(19) United States
(12) Patent Application Publication
(10) Pub. No.: US 2024/0259233 A1
(43) Pub. Date: Aug. 1, 2024

(54) SLIM ETHERNET COMMUNICATION OVER INFINIBAND

(71) Applicant: MELLANOX TECHNOLOGIES, LTD., Yokneam (IL)

(72) Inventors: Gal Shalom, Givat-Avni (IL); Omri Kahalon, Yehud (IL); Adi Horowitz, Haifa (IL); Aviad Yehezkel, Yokneam Ilit (IL); Liran Liss, Atzmon-Segev (IL); Rabia Loulou, Nazareth (IL); Matty Kadosh, Hadera (IL)

(21) Appl. No.: 18/162,938

(22) Filed: Feb. 1, 2023

(51) Int. Cl. H04L 12/46; H04L 12/66; H04L 49/351; H04L 49/356

(52) U.S. Cl. CPC H04L 12/4625; H04L 12/66; H04L 49/351; H04L 49/358

(57) ABSTRACT

Systems and methods herein are for one or more processing units to modify a network access layer of an ethernet communication to include a local route header (LRH) of an InfiniBand (IB) communication for transmission over an IB network, the modification further to retain ethernet information of all layers of the ethernet communication or to remove at least one of the layers of the ethernet communication for the IB communication.

### TECHNICAL FIELD

At least one embodiment pertains to slim ethernet communication over InfiniBand (IB) networks. For example, at least one gateway is provided to modify a network access layer of an ethernet communication to include a local route header (LRH) for an IB communication.

### BACKGROUND

Ethernet relies on Transmission Control Protocol/Internet Protocol (TCP/IP) as a network stack for connecting host machines over physical distances. Separately, InfiniBand (IB) may be used to connect such host machines while offering higher performance relative to the ethernet. For some ethernet-based applications, however, ethernet to IB interfaces may be used. The interface may apply at a link layer and may include certain management protocols. For example, in an IP over IB (IPoverIB) approach, the IP and upper protocols may be retained, while an IB's transport layer and link layer may be incorporated therein. However, the host machine remains an IB host and is not an ethernet host in such an approach. In an ethernet over IB (EoverIB) approach, an ethernet host can communicate over IB using encapsulation of ethernet host machine data as a payload within an IB stack. This can create an overhead of additional headers and may cause performance loss.

### BRIEF DESCRIPTION OF DRAWINGS

FIG. 1 illustrates a system that is subject to slim ethernet communication over InfiniBand (IB) networks, according to at least one embodiment;

FIG. 2 illustrates management aspects of a system for slim ethernet communication over IB networks, according to at least one embodiment;

FIG. 3 illustrates slim ethernet communication over IB networks using a separated slim ethernet gateway, according to at least one embodiment;

FIG. 4 illustrates slim ethernet communication over IB networks using an attached or integrated slim ethernet gateway, according to at least one embodiment;

FIG. 5 illustrates a process flow for receiving ethernet communication for slim ethernet communication over IB networks, according to at least one embodiment;

FIG. 6 illustrates process flow for receiving IB communication from slim ethernet communication over IB networks, according to at least one embodiment; and

FIG. 7 illustrates a further process flow for slim ethernet communication over IB networks, according to at least one embodiment.

### DETAILED DESCRIPTION

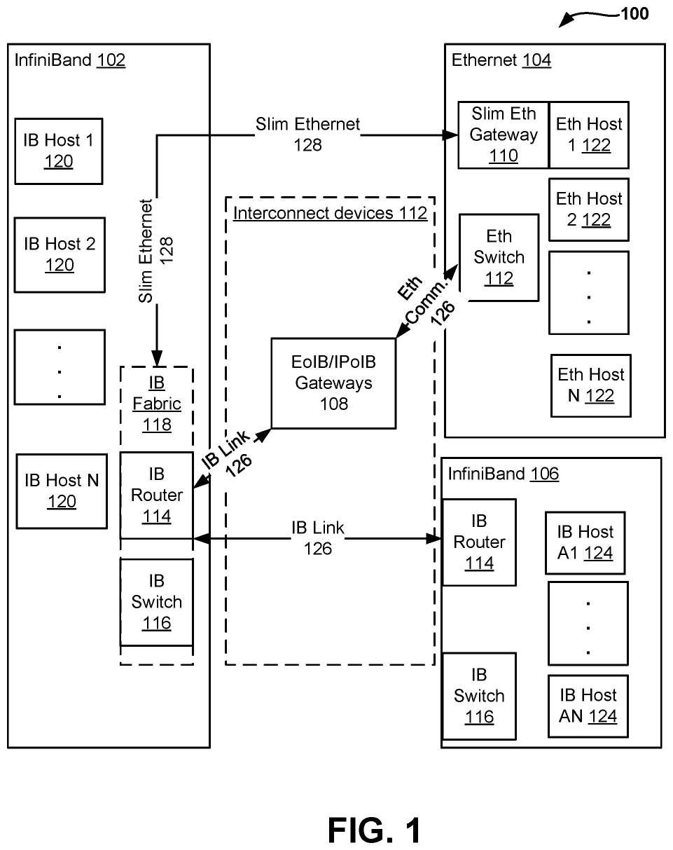

In at least one embodiment, FIG. 1 illustrates a system 100 that is subject to slim ethernet communication over InfiniBand (IB) networks, as detailed herein. Ethernet over IB networks may rely on communication protocols having multiple IB headers over the local route header (LRH), such as a global route header (GRH), base transport header (BTH), etc. All such headers may be included and further, all the layers of an ethernet communication may be retained, making it data-intensive to conduct such ethernet communications over IB networks.

In at least one embodiment, slim ethernet communication over InfiniBand (IB) networks herein pertains to reduced byte ethernet communications over IB networks. For example, modification of a network access layer (such as layer 1 (L1) and/or layer 2 (L2)) of an ethernet communication is performed. The modification may progress in two approaches. In at least one embodiment, in an overlay approach of the modification of the network access layer, an LRH for an IB communication may be added to at least part of a network access layer of an ethernet communication, with the ethernet information in all layers (such as layer 2 (L2) to the application layer) of the ethernet communication retained as in their respective layers for the IB communication. This includes retaining a part of the network access layer having the ethernet information (i.e., keeping ethernet information (ETH) of the L2 layer as-is). The ethernet information may include media access control (MAC) and logical link control (LLC).

In at least one embodiment, in a translation approach of the modification of the network access layer, the LRH in the network access layer (L2 layer) is retained, but the other ethernet information (including IP, TCP/user datagram protocol (UDP) etc.) in moved to at least the application layer and the remaining layers are removed. In at least one embodiment, both such modifications are only to the L2 layer, instead of modification to more than L2 layer or inclusion of more than the LRH.

In at least one embodiment, such modifications can be supported by a changed IB router protocol that uses a destination local identifier (DLID) in the LRH and that includes a GID-to-LID mapping in the SM, where the GID is a global identifier from a global route header (GRH) that was previously required to be sent in an IB communication and LID is a local identifier that is assigned to every IB interface, such as to every IB port. The GID may include an LID by virtue of a GID-to-LID mapping in the SM. A first portion of a GID (such as the first 64 bits) may be an assigned Subnet ID for the IB port, while a second portion of the GID (such as a second 64 bits) is the IB port's assigned GUID (global unit identifier).

In at least one embodiment, an SM assigns a same Subnet ID, which may be a GID Prefix or Subnet Prefix, to every port within its subnet. In at least one embodiment, such approaches eliminate a need for retaining additional IB headers in the other layers of the ethernet communication and so, only the L2 layer needs to be modified and the ethernet information may be fully or partly retained, which reduces the size of the ethernet communication when provided as IB communication for an IB network. Further, in the overlay approach here, a different LID may be required for different IB ports, whereas in the translation approach, an LID may be required for each ethernet interface, such as a virtual LID that may be registered in the SM for an ethernet interface.

The system 100 in FIG. 1 supports interfacing between an InfiniBand (IB) network 102 and an ethernet network 104, alongside other IB networks 106. For example, IB aspects of interconnect devices 112 may represent an IB fabric 118 and can at least include multiple IB switches 116 and IB routers 114. Such an IB fabric 118 allows one or more IB hosts 120, 124 to communicate within a subnet or across subnets over one or more designated IB links 126. Even though illustrated via IB routers, an IB link can couple together IB switches within a subnet. An IB link 126 is an abstraction that may include queue pairs (QPs) that bring together a source IB host machine and destination IB host machine for communication with each other. These IB host machines may be within a same subnet or in different subnets.

In at least one embodiment, each subnet includes a respective SM. The SM may be a centralized software service that runs on an IB switch 116. The SM performs functions for discovery of all connected ports and configures all the IB devices (such as IB routers 114 and other IB switches 116) in an IB fabric 118. The SM controls the port arrangements for traffic flow that occurs between the host machines 120 via the IB switches 116 within a subnet, for instance. The discovery and configurations of port arrangements are therefore enabled by the SM to support traffic flow between those active ports of relevant IB host machines 120, 124 via the one or more IB switches 116. The SM also applies configurations relating to network traffic, including for Quality of Service (QOS), routing, and partitioning of the IB devices in an IB fabric 118. Herein, the SM is used to support slim ethernet communications 128 through an IB network, including through the IB fabric 118, for ethernet hosts 122.

While in abstraction, an IB link 126 may be bound to a physical IB port of an IB host 120. Further, an EoverIB or an IPoverIB gateway 108 is capable of supporting IB-to-ethernet and ethernet-to-IB communication as part of a group of interconnect devices 112. However, in at least one embodiment, for byte-efficient communication from an ethernet network 104, slim ethernet communication 128 may be used between an ethernet host 122 and an IB devices of an IB fabric 118, including to communication to one or more IB hosts 120. This can be performed without a requirement for the interconnect devices 112.

All of such hosts or host machines may be computer platforms executing an Operating System (OS) to control one or more ethernet network adapters having one or more ethernet interfaces and/or ports to communicate via an IB network. However, to the OS, the provided or interfaces ports may be ethernet ports, unless configured using the SM and SMAs to function with an IB switch and other IB devices. A host is used interchangeably with a host machine to describe an IB or ethernet host unless stated expressly otherwise using preceding text IB or ethernet, where an IB host is exclusively within an IB network and an ethernet host is exclusively within an ethernet network. Further, such exclusivity does not restrict IB to ethernet communications as described throughout herein.

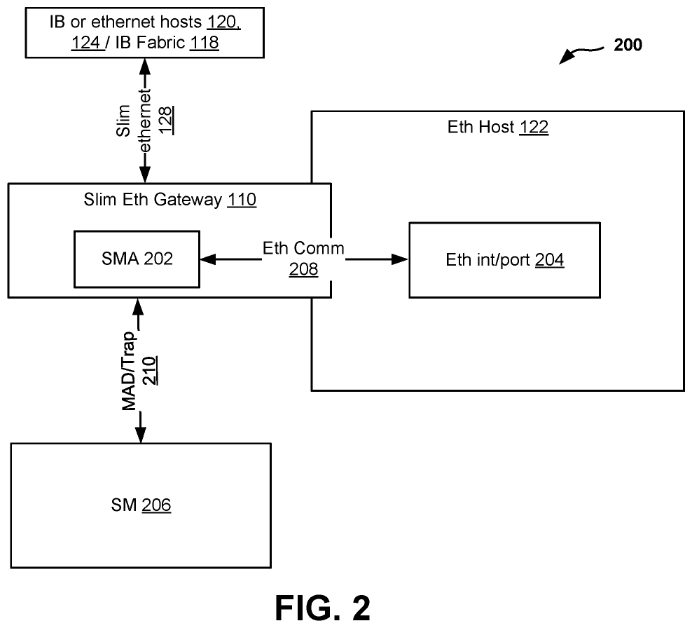

In at least one embodiment, FIG. 2 illustrates management aspects of a system 200 for slim ethernet communication over IB networks. An ethernet host 122 can be exposed to an ethernet interface 204, which may include an ethernet port or an ethernet network interface controller (NIC). However, an IB interface in the form of a slim ethernet gateway 110 is also associated with such an ethernet host 122. In at least one embodiment, the slim ethernet gateway 110 includes a subnet management agent (SMA) 202 that operates transparently. The SMA 202 may be in the form of hardware, firmware, or software. The slim ethernet gateway 110 or part of the slim ethernet gateway 110 may be implemented using a data processing unit (DPU) for each physical ethernet interface 204.

In at least one embodiment, the ethernet interface 204 may be associated with a first local identifier (LID) that may be provided from a subnet manager (SM) 206. Separately, an IB interface (such as of the slim ethernet gateway 110) may be associated with a second local identifier (LID). In one example, the SMA 202 communicates with the SM 206 using management datagram (MAD) or trap messaging 210 to secure the first and second LIDs. The first LID may be a virtual LID as the ethernet interface 204 is not in the IB devices and the ethernet interface 204 will be considered as an IB virtual port (VPORT) for purposes of operations herein.

An SM 206 may be configured with a subnet to enable the SM 206 to monitor the subnet for any changes. This may be a monitoring phase for the SM 206. Such changes may include changes in the IB subnet of an IB network, including an IB link failure or an IB device being added or removed. In at least one embodiment, for a subnet that includes an SMA 202 of a slim ethernet gateway 110, for communication between an ethernet network and an IB network, changes from the SMA 202 may be communicated to the underlying SM 206 of a subnet.

In at least one embodiment, in the monitoring phase, each IB device in a subnet and each SMA that is active may forward a trap message to the SM 206. For example, the SM 206 may notify all IB devices and SMAs of a monitoring phase and the IB devices and SMAs may response by trap message or messaging to the SM. The SM 206 can reconfigure its subnet, including to allow rerouting of traffic to certain ones of the IB devices, such as IB routers, IB switches, and the endpoints, including to the host machines 120, 124 illustrated.

In at least one embodiment, the MAD messaging 210 from the SM 206 allows trap messaging to be sent back to the SM 206. The trap messaging may include notifying the SM of a change for physical IB ports or for SMAs associated with a slim ethernet gateway 110. Further, in the monitoring phase, an SM 206 can monitor a subnet for changes by communicating with respective SMAs. The SMAs are, however, in every IB device to enable such communications. Still further, using at least the trap messaging, the SMAs communicate the above-referenced changes, such as changes in related ports (state changes) and connections and disconnections of IB devices or IB links, to the SM 206 of a subnet.

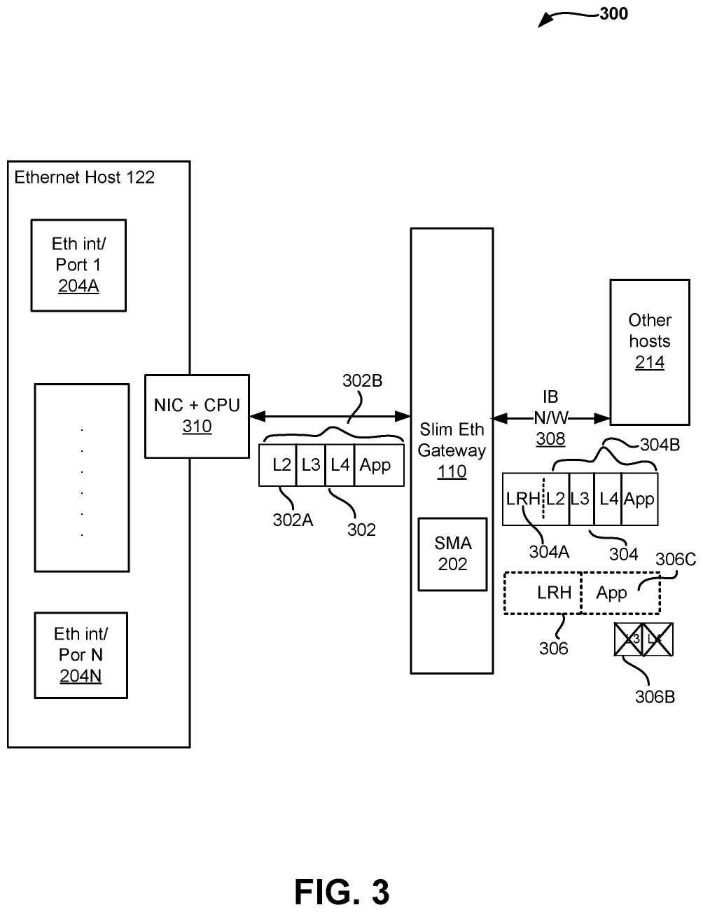

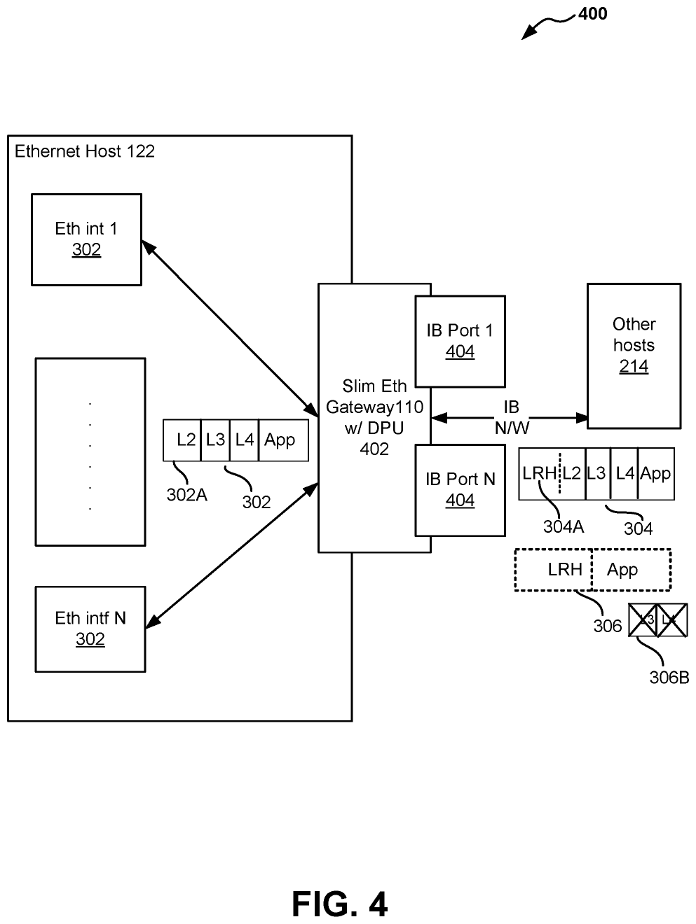

In at least one embodiment, trap messages can be sent to alert about events and can include a notice attribute providing details of such events. Therefore, trap messages herein are defined to communicate events for physical IB ports and for SMAs of slim ethernet gateways 110 and MAD messaging may provide configuration information to enable the slim ethernet gateways to functions as described further with respect to FIGS. 3, 4, and to at least one IB switch to configure a forwarding table based in part on a mapping provided from the SM 206 of a subnet. This enables ethernet and IB host machines to communicate with other host machines.

In at least one embodiment, FIG. 3 illustrates slim ethernet communication 300 over IB networks using a separated slim ethernet gateway 110. The ethernet host 122 includes one or more ethernet interfaces 204A-N, which may include an ethernet port and which may be coupled to an ethernet network interface controller (NIC) 310. The NIC 310 may be further supported by a central processing unit (CPU). An IB interface, in the form of a slim ethernet gateway 110, is also associated with such an ethernet host 122 and particularly with its NIC 310. The slim ethernet gateway 110 includes a subnet management agent (SMA) 202 that operates transparently, such as to not be visible to an OS of the ethernet host 122.

In at least one embodiment, each of the physical ports associated with the ethernet host 122, such as the IB port associated with the IB interface of the slim ethernet gateway 110 and the ethernet ports of the ethernet interface on the host 122, will be assigned respective LIDs. With respect to the ethernet interface, each interface port will be considered as an IB virtual port (VPORT) and will assigned a LID from the SM 206 on that basis and the representation made by the SMA 202. Moreover, a GUID table provided to the SMA from the SM 202 will include the MACs associated with the physical ports of the host machine 122 (including the slim ethernet gateway 110).

In at least one embodiment, an ethernet communication 302, from an ethernet host 122 is sent via the ethernet interface 310 to the slim ethernet gateway 110. For example, the NIC 310 passes the ethernet communication 302 to a physical port of slim ethernet gateway 110 representing an IB interface. The ethernet communication 302 may include L2, L3, L4, and application layers. At least the L2 layer may be a data link layer and may include a source and destination MACs associated with a source host (such as the ethernet host 122) and with a destination host (one of the other hosts 214). L3 may be a network layer and may specify the protocol (such as, UDP, TCP, etc.) of a subsequent L4 or transport layer. L4 provides details of the transport, including the source and destination ports, acknowledgement, etc. The application layer provides protocols indicative of the application (such as, Hypertext Transfer Protocol (HTTP), File Transfer Protocol (FTP), etc.) associated with the ethernet communication.

The SMA 202 of the slim ethernet gateway 110 enables it to query the SM 206 about an IB information corresponding to the ethernet communication, such as an assigned LID of a destination for the ethernet communication 302. For example, using the source and destination MACs provided by the slim ethernet gateway 110 with a PathQuery command to the SM 206 will enable the SM 206 to return at least LIDs usable to prepare the LRH 304A for an IB communication 304. The slim ethernet gateway 110 can prepare the LRH 304A to include the source and destination LIDs as provided by the SM 206.

The LRH 304A is prepended to the other layers of the ethernet communication 302 with the L2 304A removed to provide an IB communication 304. This is a modification of the ethernet communication 302 and the IB communication is sent to the wire (such as an IB port) for communication to an IB network 308 for receipt by a destination host of the other hosts 214 via an IB fabric 118. The destination host may be an IB or an ethernet host. In the case of an ethernet host, a respective slim ethernet gateway can be associated with such an ethernet host to reverse the modification of the ethernet communication.

On the receiving side, the slim ethernet communication 304 is expected to reach to one or more of the other hosts 214 over the IB network 308 without any issues because the IB network 308 uses only the LRH to forward the slim ethernet communication 304. The received slim ethernet communication 304 is received on an IB interface of the one or more other hots 214. A similar slim ethernet gateway 110 on the receiving side enables removal of the LRH and enables the received slim ethernet communication 304 to be forwarded as regular ethernet communication to the intended ethernet interface of the receiving host 214, according to the destination MAC in the regular ethernet communication. For example, the receiving slim ethernet gateway can query the SM 206 to find the corresponding MAC to any LID in the LRH.

In at least one embodiment, in an IB fabric 118, global identifiers (GIDs) may be associated with one of the interconnect devices 112, such as an IB gateway 108, to support communication between an IB network and other protocol networks, including ethernet networks 104. Further, a GID is a 128-bit number used to identify an IB port on one or more network adapters of one or more IB host machines 120, on one or more IB routers 114, or on one or more IB gateways 108. The GIDs may be distributed for the IB ports via the SM 206. However, the method and system for slim ethernet communication herein uses a unique LRH in which the destination LID is prepare using a simplified GID-to-LID mapping in the SM 206. For example, the LID includes 16 LSB bits of GID. This avoids a requirement to send for an Address Resolution Protocol (ARP) query. The GID is previously part of the GRH, which is not provided in the slim ethernet communication to support reduced byte ethernet communications over IB networks.

An IB host machine or node 120 can initiate traffic flow through one of the IB gateways 108, IB switches 116, or IB routers 114. To do so, an IB host 120 can send or broadcast a request to one of the IB devices using its LID address for a host machine in the same subnet and which can be mapped to a GID address for a host machine in another subnet. For ethernet communication, slim ethernet communications may be used as described herein.

The system for ethernet communication 304 over an IB network 308 therefore includes at least one slim ethernet gateway 110 to modify a network access layer 302A of an ethernet communication 302 to include an LRH 304A for an IB communication 304. The modification is further to retain ethernet information 302B of all the layers of the ethernet communication in the IB communication 304. Alternatively, the modification is further to remove 306B at least one of the layers of the ethernet communication, such as L3 and L4, to provide the IB communication 306.

In at least one embodiment, where ethernet information 302B of all the layers of the ethernet communication is to be retained, the slim ethernet gateway 110 may be configured to perform the modification further by the inclusion of the LRH 304A in at least a first part of the network access layer 302A having L2. This is done by retaining a first portion of the ethernet information 302A (such as ETH information) in at least one second part of the network access layer (illustrated by the dotted line separation in L2 304A) and by retaining a second portion of the ethernet information in the other layers (L2-application being unchanged) 304B for the IB communication.

In at least one embodiment, where removal of at least one of the layers 306B of the ethernet communication is to be performed, the slim ethernet gateway 110 is to perform the modification further by inclusion, within an application layer 306C of the IB communication 306, of the ethernet information 302B of the at least one of the other layers 306B of the ethernet communication that is removed. Further, some of the ethernet information in L2, for instance, may be fully removed because the SM is able to provide lookup using the LID provided in a GUID table for the IB communication 306.

In at least one embodiment, FIG. 4 illustrates slim ethernet communication 400 over IB networks using an attached or integrated slim ethernet gateway 402. Different than in FIG. 3, the slim ethernet gateway 110 is supported by a data processing unit (DPU) 402 that can perform the slim ethernet modifications and that can include an SMA to communicate with an SM. As such, the reference to a DPU 402 is a reference to a slim ethernet gateway 110 executing on the DPU 402. Further, the attached or integrated slim ethernet gateway 402 implies that the DPU 402 is part of the ethernet host 122 as a plug-and-play card installed and in communication with an ethernet interface of the ethernet host 122. Therefore, as illustrated in FIGS. 3 and 4, the slim ethernet gateway 110/402 can be a hardware component, a firmware component, or a software component that is associated with a host machine 122. There are IB interfaces that can include IB ports 404 to communicate with the IB network and with other hosts 214, but also with other IB devices of an IB fabric 118.

In at least one embodiment, in each of the slim ethernet communications 300, 400, a SMA may be associated with a data processing unit DPU 402 and with individual physical ports of the slim ethernet gateway 110. An SM 206 is provided to communicate destination information with the SMA to enable the slim ethernet gateway 110 to prepare the LRH for the IB communication. The slim ethernet gateway 110 is further configured to query the SM for the destination information associated with a destination media access control (MAC) that is associated with a destination of the IB communication. This may be via MAD/trap messaging. The SM communicates the destination information in response to the query. In at least one embodiment, the query includes a destination local identifier (DLID) of a destination IB device associated with the destination MAC identifier.

In at least one embodiment, in each of the slim ethernet communications 300, 400, an IB interface of the slim ethernet gateway 110 can receive a IB communication that is a slim ethernet communication. Then, an SMA that is associated with the IB interface can enable removal of an associated LRH from the received IB communication. The removal of the associated LRH provides an ethernet communication, such as the original ethernet communication prior to the modification to provide the IB communication. The ethernet communication can be forwarded through one or more ethernet devices to a destination ethernet device according to a MAC identifier associated with the second ethernet communication.

In at least one embodiment, in each of the slim ethernet communications 300, 400, the slim ethernet gateway 110 can enable the ethernet communication received to an IB interface to include a source MAC of the IB interface (being the source host machine 122) and a destination MAC of the destination ethernet device, such as one of the other hosts 214. Further, the source MAC and the destination MAC are obtained by a query to the subnet manager (SM) or is included in an application layer of the IB communication 304; 306.

In at least one embodiment, in each of the slim ethernet communications 300, 400, an ethernet interface (such as including one or more ethernet ports 302) may be associated with a first local identifier (LID). An IB interface (such as a DPU 402 of the slim ethernet gateway 110) may be associated with a second local identifier (LID). The IB interface can receive the ethernet communication 302 from the ethernet interface 302. The IB interface can query an SM via a SMA for a DLID to be provided in a GUID table from the SM. The SM may include a GUID table of all physical port (including the VPORT) LIDs and their associated MACs. The SM can communicate the GUID table to the SMA to enable the slim ethernet gateway 110 to prepare the LRH for the IB communication from information in the GUID table. The slim ethernet gateway 110 is enabled to transmit the IB communication through the IB network from one or more IB ports 404.

In at least one embodiment, the system in FIGS. 1-4 is enabled by one or more processing units to modify a network access layer 302A of an ethernet communication 302 to include an LRH 304A of an IB communication 304 for transmission over an IB network. The processor units may be a DPU or may be a GPU with communication capabilities. The modification may be to retain ethernet information of all layers 302B of the ethernet communication 302 or to remove at least one 306B of the layers of the ethernet communication for the IB communication 304; 306 over the IB network 308.

The one or more processors may include a DPU to support the slim ethernet gateway 110 and may be configured to perform the modification further by the inclusion of the LRH in at least a first part of the network access layer. The modification is further by retaining a first portion of the ethernet information in at least one second part of the network access layer (as illustrated by the left side of the dotted separation in the L2 304A layer). The modification is still further by retaining a second portion of the ethernet information in their respective layers (illustrated by the right side of the dotted separation in the L2 304A layer) for the IB communication. Alternatively, the modification is further by inclusion, within an application layer 306C of the IB communication 306, of the ethernet information 306B of the at least one of the layers of the ethernet communication that is removed.

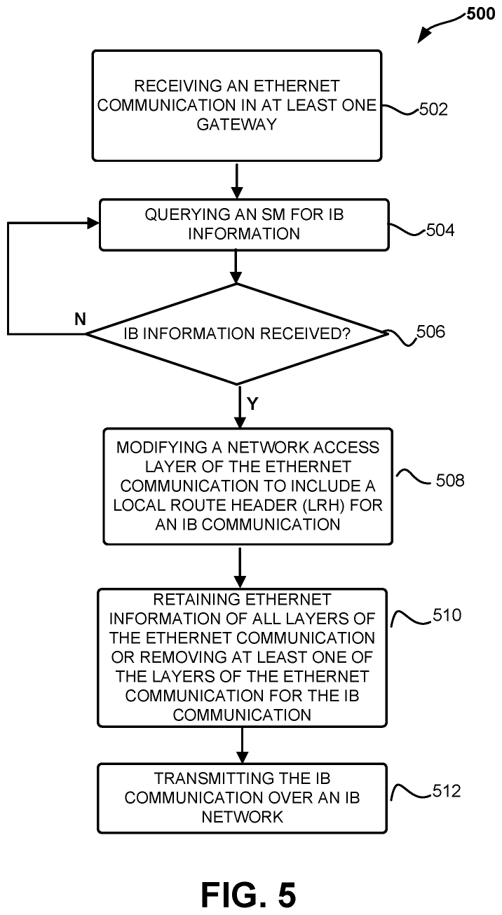

In at least one embodiment, FIG. 5 illustrates a process flow or method 500 for receiving ethernet communication for slim ethernet communication over IB networks. The method 500 includes receiving (502) an ethernet communication in a slim ethernet gateway. The method 500 includes querying (504) an SM for IB information. The method 500 may include verifying (506) that the IB information corresponding to the ethernet communication is received, such as by a query from the slim ethernet gateway to the SM. On positive verification, the method 500 includes modifying (508) a network access layer of the ethernet communication to include an LRH that is prepared from the IB information and that is for an IB communication.

The method 500 includes retaining (510), as part of the modification, ethernet information of all layers of the ethernet communication into the IB communication. Alternatively, the method 500 may remove, as part of step 510 and as part of the modification, at least one of the layers of the ethernet communication for the IB communication. The method 500 includes transmitting (512) the IB communication over an IB network.

In at least one embodiment, the method 500 may include a further step or substep for configuring the slim ethernet gateway to perform the modification further by the inclusion of the LRH in at least a first part of the network access layer. Within this step or substep is further feature to retain a first portion of the ethernet information in at least one second part of the network access layer and to retain a second portion of the ethernet information in at least one remaining layer of the ethernet communication for the IB communication.

In at least one embodiment, the method 500 may include a further step or substep for the slim ethernet gateway to perform the modification of steps 508, 510, further by inclusion, within an application layer of the IB communication, of the ethernet information of the at least one of the layers of the ethernet communication that is removed. The method 500 may include a further step or substep for querying, by the slim ethernet gateway, the SM for the destination information, pertaining to the IB information in verification step 506, where the destination information is associated with a destination media access control (MAC). The MAC is associated with a destination of the IB communication, wherein the SM communicates the destination information in response to the query.

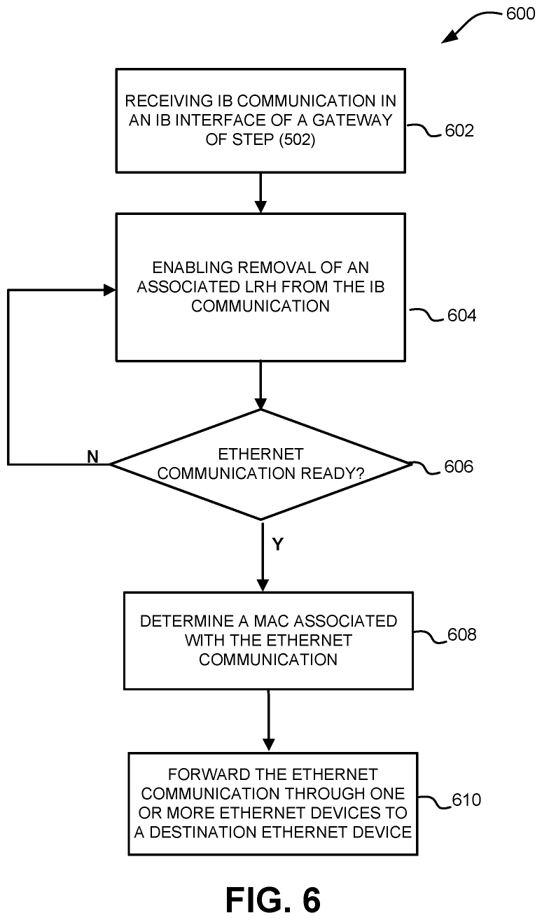

In at least one embodiment, FIG. 6 illustrates process flow or method 600 for receiving IB communication from slim ethernet communication over IB networks. The method 600 includes receiving (602), in an IB interface, an IB communication. The IB interface may be an IB port associated with a DPU supporting a slim ethernet gateway. The method 600 includes enabling (604) removal of an associated LRH from the IB communication. The removal of the associated LRH provides an ethernet communication. The method 600 includes verifying (606) that the ethernet communication is ready for transmission. The verification may be by receipt or acknowledgement of an ethernet port ready to transmit the ethernet communication. The method 600 includes determining (608) a MAC associated with a MAC, such as at least a destination MAC for the ethernet communication. The method 600 includes forwarding (610) the ethernet communication, through one or more ethernet devices, to a destination ethernet device according to at least the MAC associated with the ethernet communication.

In at least one embodiment, the method 600 includes further steps or substeps for enabling, by the slim ethernet gateway, the ethernet communication to include a source MAC of the IB interface and a destination MAC of the destination ethernet device. Here, the source MAC and the destination MAC can be obtained by a query to the subnet manager (SM) or is included in an application layer of the IB communication.

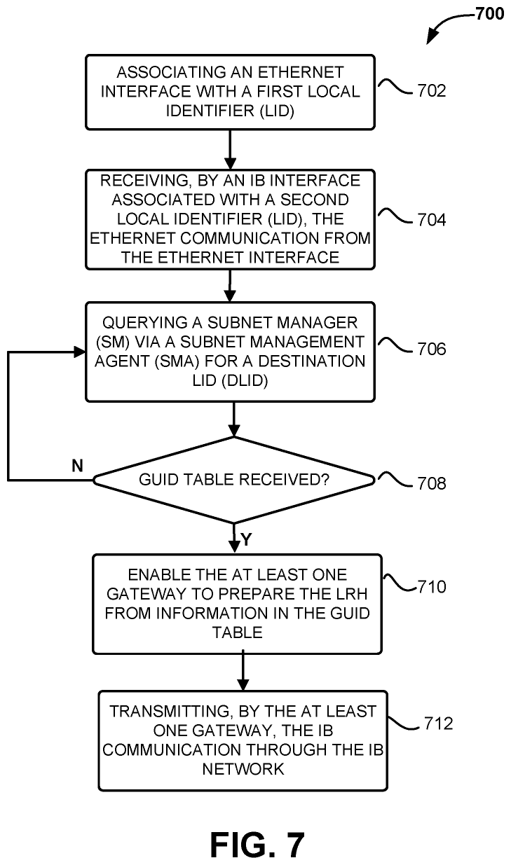

In at least one embodiment, FIG. 7 illustrates a further process flow or method 700 for slim ethernet communication over IB networks. The method 700 includes associating (702) an ethernet interface with a first local identifier (LID). Further, the method 700 includes receiving (704), by an IB interface associated with a second local identifier (LID), the ethernet communication from the ethernet interface. As described with respect to at least FIG. 2, all ports, ethernet or IB, associated with the slim ethernet gateway receive a LID. The method 700 includes querying (706) an SM via an SMA for a DLID to be provided in a GUID table. A verification (708) may be performed that the GUID table is received or is a latest copy based on a latest discovery performed by the SM.

The method 700 of FIG. 7 includes enabling (710) the slim ethernet gateway to prepare the LRH for the IB communication from information in the GUID table. Further, the method 700 includes transmitting (712), by the slim ethernet gateway, the IB communication through the IB network. In at least one embodiment, the slim ethernet gateway is to modify only the L2 layer of the ethernet communication to include the LRH. In at least one embodiment, the slim ethernet gateway is to modify the ethernet communication to retain the ethernet information therein but to include only an LRH in the L2 layer for IB communication.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for ethernet communication over an InfiniBand (IB) network, comprising:
at least one gateway to modify a network access layer of an ethernet communication to include a local route header (LRH) for an IB communication, the modification to further retain ethernet information of all layers of the ethernet communication or to remove at least one of the layers of the ethernet communication for the IB communication.

2. The system of claim 1, wherein the at least one gateway is configured to perform the modification further by the inclusion of the LRH in at least a first part of the network access layer, by retaining a first portion of the ethernet information in at least one second part of the network access layer, and by retaining a second portion of the ethernet information in their respective layers for the IB communication.

3. The system of claim 1, wherein the at least one gateway is to perform the modification further by inclusion, within an application layer of the IB communication, of the ethernet information of the at least one of the layers of the ethernet communication that is removed.

4. The system of claim 1, further comprising the at least one gateway as a hardware component, a firmware component, or a software component that is associated with a host machine.

5. The system of claim 1, further comprising:
a subnet management agent (SMA) associated with a data processing unit (DPU) and with individual physical ports of the at least one gateway; and
a subnet manager (SM) to communicate destination information with the SMA to enable the at least one gateway to prepare the LRH for the IB communication.

6. The system of claim 5, wherein the at least one gateway is further configured to:
query the SM for the destination information associated with a destination media access control (MAC) that is associated with a destination of the IB communication, wherein the SM communicates the destination information in response to the query.

7. The system of claim 6, wherein the query comprises a destination local identifier (DLID) of a destination IB device associated with the destination MAC identifier.

8. The system of claim 1, further comprising:
an IB interface of the at least one gateway to receive a second IB communication; and
an SMA associated with the IB interface to enable removal of an associated LRH from the second IB communication, wherein removal of the associated LRH provides a second ethernet communication, and wherein the second ethernet communication is to be forwarded through one or more ethernet devices to a destination ethernet device according to a MAC identifier associated with the second ethernet communication.

9. The system of claim 8, wherein the at least one gateway is further configured to:
enable the second ethernet communication to include a source MAC of the IB interface and a destination MAC of the destination ethernet device, wherein the source MAC and the destination MAC are obtained by a query to the subnet manager (SM) or is included in an application layer of the IB communication.

10. The system of claim 1, further comprising:
an ethernet interface associated with a first local identifier (LID);
an IB interface associated with a second local identifier (LID) to receive the ethernet communication from the ethernet interface and to query a subnet manager (SM) via a subnet management agent (SMA) for a destination LID (DLID) to be provided in a global unique identifier (GUID) table; and
a subnet manager (SM) to communicate the GUID table to the SMA to enable the at least one gateway to prepare the LRH for the IB communication from information in the GUID table and to enable the at least one gateway to transmit the IB communication through the IB network.

11. A method for ethernet communication over an InfiniBand (IB) network, comprising:
receiving an ethernet communication in at least one gateway;
modifying a network access layer of the ethernet communication to include a local route header (LRH) for an IB communication;
retaining, as further part of the modification, ethernet information of all layers of the ethernet communication into the IB communication or removing, as the further part of the modification, at least one of the layers of the ethernet communication for the IB communication; and
transmitting the IB communication over an IB network.

12. The method of claim 11, further comprising:
configuring the at least one gateway to perform the modification further by the inclusion of the LRH in at least a first part of the network access layer, by retaining a first portion of the ethernet information in at least one second part of the network access layer, and by retaining a second portion of the ethernet information in at least one remaining layer of the ethernet communication for the IB communication.

13. The method of claim 11, further comprising:
performing, using the at least one gateway, the modification further by inclusion, within an application layer of the IB communication, of the ethernet information of the at least one of the layers of the ethernet communication that is removed.

14. The method of claim 13, further comprising:
querying, by the at least one gateway, the SM for the destination information associated with a destination media access control (MAC) that is associated with a destination of the IB communication, wherein the SM communicates the destination information in response to the query.

15. The method of claim 11, further comprising:
receiving, in an IB interface of the at least one gateway, a second IB communication; and
enabling removal of an associated LRH from the second IB communication, wherein removal of the associated LRH provides a second ethernet communication, and wherein the second ethernet communication is to be forwarded through one or more ethernet devices to a destination ethernet device according to a MAC identifier associated with the second ethernet communication.

16. The method of claim 15, further comprising:
enabling, by the at least one gateway, the second ethernet communication to include a source MAC of the IB interface and a destination MAC of the destination ethernet device, wherein the source MAC and the destination MAC are obtained by a query to the subnet manager (SM) or is included in an application layer of the IB communication.

17. The method of claim 11, further comprising:
associating an ethernet interface with a first local identifier (LID);
receiving, by an IB interface associated with a second local identifier (LID), the ethernet communication from the ethernet interface;
querying a subnet manager (SM) via a subnet management agent (SMA) for a destination LID (DLID) to be provided in a global unique identifier (GUID) table; and
communicating, by the subnet manager (SM), the GUID table with the SMA to enable the at least one gateway to prepare the LRH for the IB communication from information in the GUID table; and
transmitting, by the at least one gateway, the IB communication through the IB network.

18. A system comprising:
one or more processing units to modify a network access layer of an ethernet communication to include a local route header (LRH) for an InfiniBand (IB) communication for transmission over an IB network, the modification further to retain ethernet information of all layers of the ethernet communication or to remove at least one of the layers of the ethernet communication for the IB communication.

19. The system of claim 18, wherein the at least one gateway is configured to perform the modification further by the inclusion of the LRH in at least a first part of the network access layer, by retaining a first portion of the ethernet information in at least one second part of the network access layer, and by retaining a second portion of the ethernet information in their respective layers for the IB communication.

20. The system of claim 18, wherein the at least one gateway is to perform the modification further by inclusion, within an application layer of the IB communication, of the ethernet information of the at least one of the layers of the ethernet communication that is removed.
